(19) United States
(12) Patent Application Publication
(10) Pub. No.: US 2009/0301054 A1
(43) Pub. Date: Dec. 10, 2009

(54) TURBINE SYSTEM HAVING EXHAUST GAS RECIRCULATION AND REHEAT

(76) Inventors: Stanley F. SIMPSON, Simpsonville, SC (US); George M. Gilchrist, Greenville, SC (US); Hasan Karim, Greenville, SC (US)

Correspondence Address: NIXON & VANDERHYE P.C., 901 NORTH GLEBE ROAD, 11TH FLOOR, ARLINGTON, VA, 22203, US

(21) Appl. No.: 12/133,065

(22) Filed: Jun. 4, 2008

(51) Int. Cl. F02C 6/04; F02C 3/34; F01K 23/06

(52) U.S. Cl. 60/39.15; 60/39.52; 60/670; 60/772

(57) ABSTRACT

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

### FIELD OF THE INVENTION

The present invention relates to a turbine system having a gas turbine with a reheat combustion system and an exhaust gas recirculation (EGR) system for the reduction of thermal NOx.

### BACKGROUND OF THE INVENTION

As concerns over the environmental impact of industrial emissions have increased, so too have the restrictions on allowable emissions. Large gas turbine systems are of a particular concern due to the considerable quantities of fuel required to meet electricity demands. A number of combustion schemes have been developed to reduce emissions that result from the high turbine firing temperatures currently in use on most commercial systems. Some of these combustion schemes include premixed combustion, staged combustion, atomized liquid fuel, injection of various diluents, catalytic combustion, exhaust gas recirculation (EGR), and reheat combustion.

In a typical reheat turbine system, the reheat combustor is located downstream of the primary combustor and provides typically greater efficiency and lower emissions. EGR is often used to reintroduce exhaust gases into a section of the turbine, such as the inlet or the combustion chamber, in order to improve emissions benefits by lowering temperature in high temperature gas pockets and also reducing oxygen concentration.

### BRIEF DESCRIPTION OF THE INVENTION

In one embodiment, a turbine system comprises a first compressor configured to compress gases; a first combustor configured to mix the compressed gases with fuel and burn the mixture; a first turbine configured to be driven by combustion gases of the first combustor; a second combustor configured to mix exhaust gases from the first turbine with fuel and burn the mixture; a second turbine configured to be driven by combustion gases from the second combustor; and a generator configured to be driven the turbine system. A first portion of the exhaust gases from the second turbine is recirculated for mixing in the first combustor.

In another embodiment, a method of operating a turbine system comprises compressing gases with a first compressor; mixing the compressed gases with fuel to form a first mixture and burning the first mixture; driving a first turbine with combustion gases from burning the first mixture; mixing exhaust gases from the first turbine with fuel to form a second mixture and burning the second mixture; driving a second turbine with combustion gases from burning the second mixture; and recirculating a first portion of the exhaust gases from the second turbine into the first mixture.

In a further embodiment, a turbine system comprises a plurality of compressors, each compressor configured to compress gases; a plurality of combustors, each combustor configured to mix compressed gases with fuel and burn the mixture; a plurality of turbines, each turbine configured to be driven by combustion gases of at least one of the plurality of combustors; and a generator configured to be driven by the turbine system. Portions of the exhaust gases from at least some of the turbines are recirculated and introduced into at least some of the compressors.

### BRIEF DESCRIPTION OF THE DRAWINGS

FIG. 1 schematically illustrates a sample embodiment of a reheat turbine system having a single shaft;

FIG. 2 schematically illustrates another sample embodiment of a reheat turbine system having a single shaft;

FIG. 3 schematically illustrates another sample embodiment of a reheat turbine system having a single shaft;

FIG. 4 schematically illustrates a sample embodiment of a reheat turbine system having a dual shaft configuration;

FIG. 5 schematically illustrates another sample embodiment of a reheat turbine system having a concentric dual shaft;

FIG. 6 schematically illustrates another sample embodiment of a reheat turbine system having a concentric shaft arrangement; and

FIG. 7 schematically illustrates a sample embodiment of a reheat turbine system having a concentric shaft arrangement.

### DETAILED DESCRIPTION OF THE INVENTION

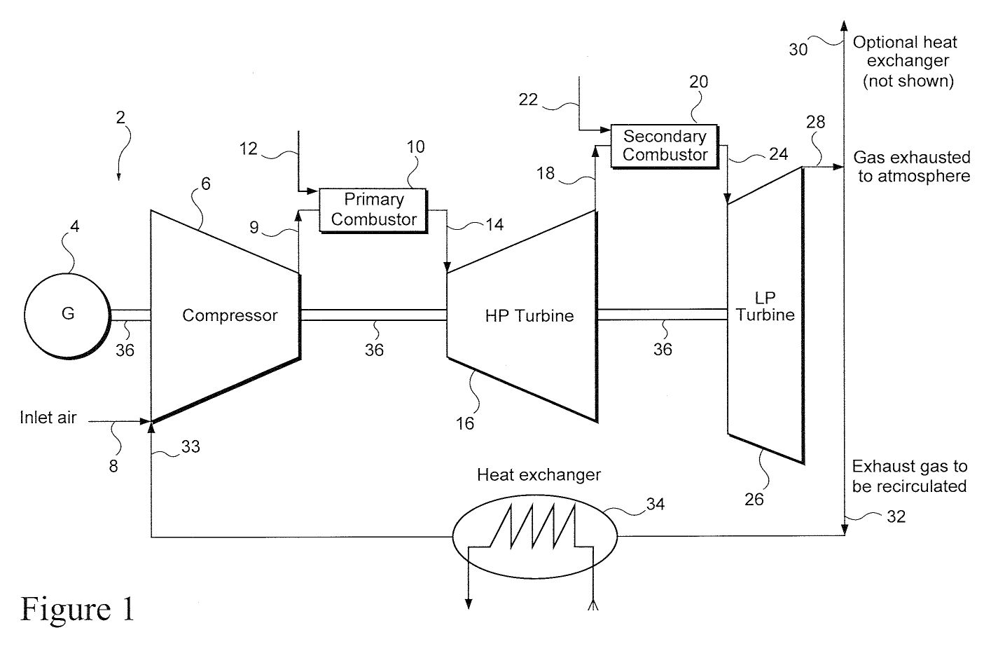

Referring to FIG. 1, a turbine system 2 according to a sample embodiment comprises a generator 4 operatively connected to a compressor 6 by a shaft 36. The compressor 6 may be operated at a constant rotational speed so that the quantity of inlet air 8 is maintained constant. The compressed air is fed to a primary combustion chamber, or combustor, 10 where it is mixed with fuel 12. The preparation of the fuel 12 may be effected by, for example, a coal gasification system.

The amount of air provided to the primary combustor 10 by the compressor 6 exceeds the amount of air necessary for combusting the fuel 12. The combustion gases 14 from the primary combustor 10, which includes the excess air, are fed to a high pressure turbine 16 which is connected to the compressor by the shaft 36. The high pressure turbine exhaust gas 18 is fed to a secondary, or reheat, combustor 20 and mixed with fuel 22. The combustion gases 24 from the secondary combustor 20 are fed to a low pressure turbine 26 which is connected to the high pressure turbine 16, the compressor 6, and the generator 4 by the shaft 36. The connection of the generator 4, the compressor 6, the high pressure turbine 16, and the low pressure turbine 26 allows the components to run at the same speed.

The low pressure turbine exhaust gases 28 are divided into atmosphere exhaust gases 30 and recirculated exhaust gases 32. The atmosphere exhaust gases 30 are exhausted to the atmosphere, for example, through an optional heat exchanger (not shown).

The recirculated exhaust gases 32 are fed through a heat exchanger 34 and the cooled, uncompressed recirculated exhaust gases 33 are then fed into the compressor 6 with the inlet air 8. The heat removed from the recirculated exhaust gases 32 by the heat exchanger 34 may be used to operate a steam turbine apparatus, for example, so that the system may be a combined cycle system.

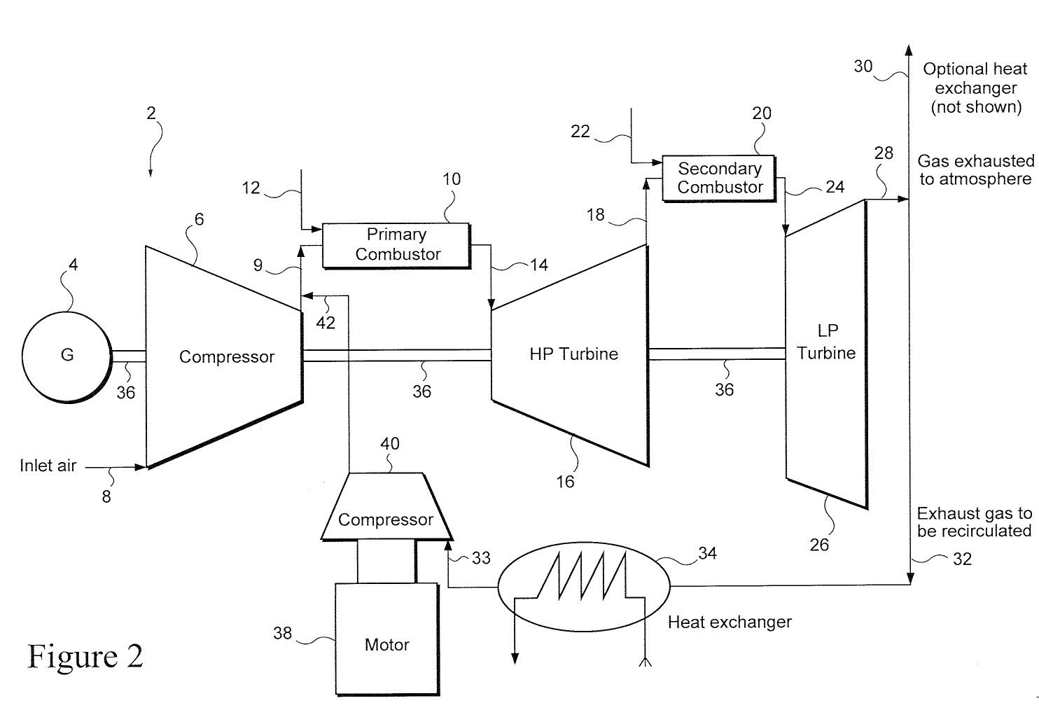

Referring to FIG. 2, in another sample embodiment of a turbine system 2, the recirculated exhaust gases 32 are passed through the heat exchanger 34 and the cooled, uncompressed recirculated exhaust gases 33 are fed to a compressor 40 which is driven by a motor 38 or other device. The compressed, cooled recirculated exhaust gas 42 is fed to the line from the compressor 6 to the primary combustor 10. The compressed recirculated exhaust gas 42 is thus mixed with the compressed inlet air 8 and the resulting compressed air and gases 9 are fed to the primary combustor 10.

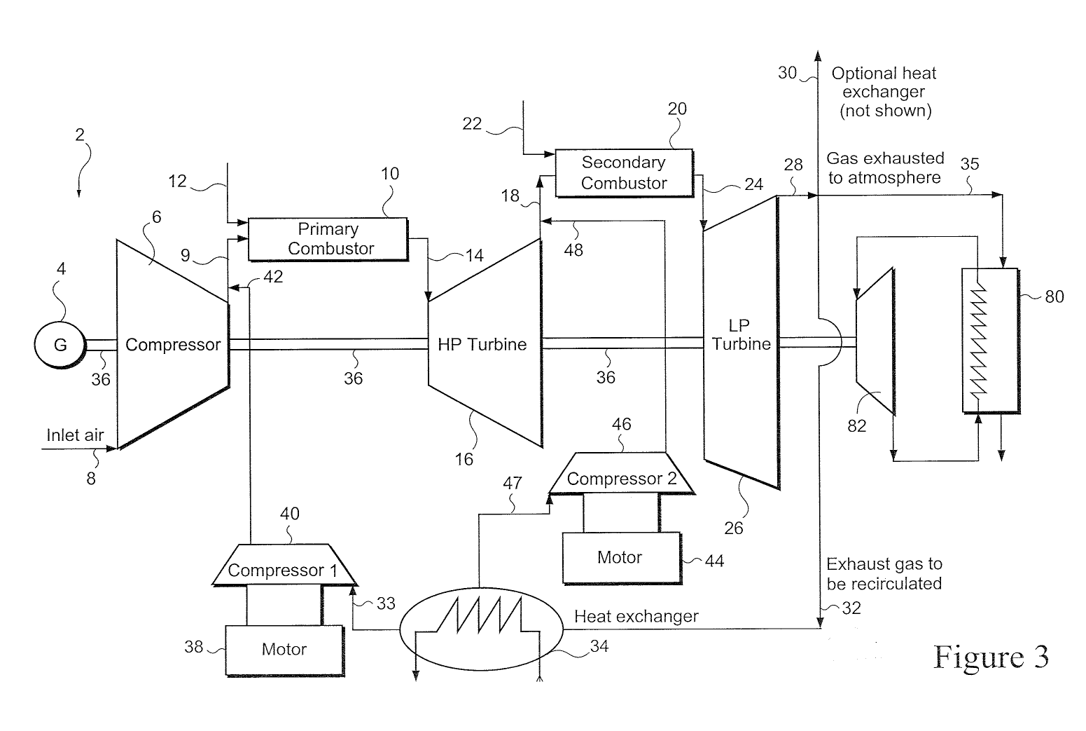

As shown in FIG. 3, according to another sample embodiment of a turbine system 2, partially cooled, uncompressed recirculated exhaust gases 47 are fed from the heat exchanger 34 to a second compressor 46 operated by a second motor 44. The compressed, partially cooled recirculated exhaust gas 48 is fed from the compressor 46 to the line from the high pressure turbine 16 to the secondary combustor 20 to be mixed with the high pressure turbine exhaust gas 18.

A second portion 35 of the low pressure turbine exhaust gases 28 may be routed to a HRSG (heat recovery steam generator) 80. The HRSG 80 generates steam to operate a steam turbine 82 so that the system may be a combined cycle configuration. It should be appreciated that any of the embodiments described herein may be provided with a HRSG and steam turbine to provide a combined cycle configuration.

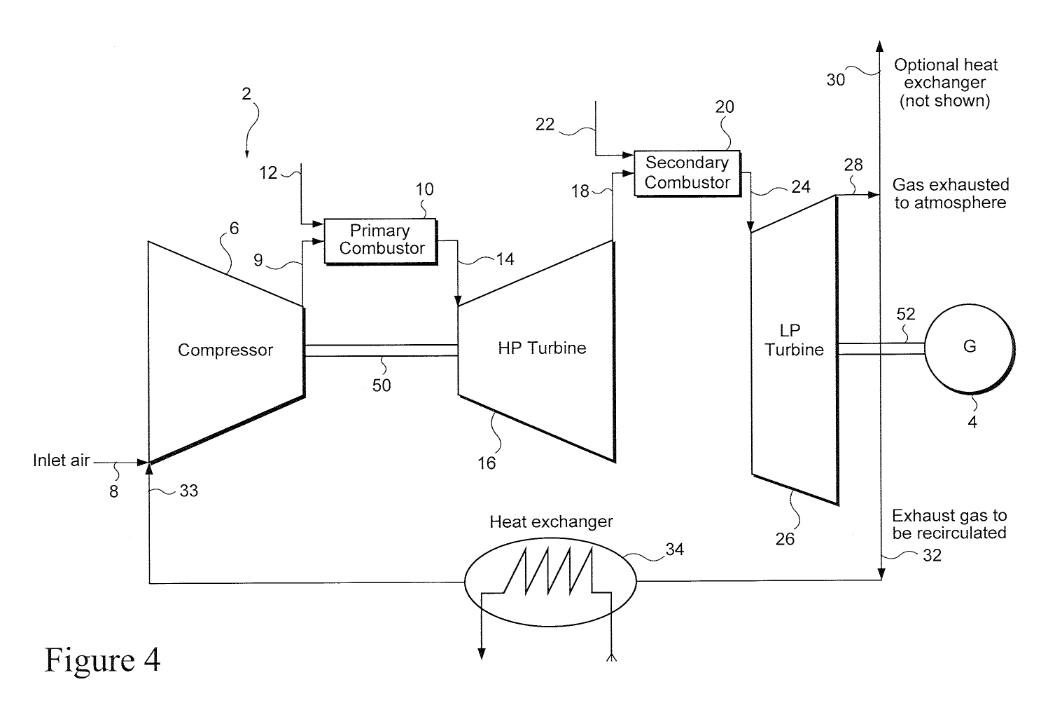

Referring to FIG. 4, a turbine system 2 according to another sample embodiment comprises dual shafts 50, 52. The compressor 6 and the high pressure turbine 16 are connected by a first shaft 50 and the low pressure turbine 26 and the generator 4 are connected by a second shaft 52. The first shaft 50 ensures that the compressor 6 and the high pressure turbine 16 rotate at the same speed and the second shaft 52 ensures that the low pressure turbine 26 and the generator 4 rotate at the same speed.

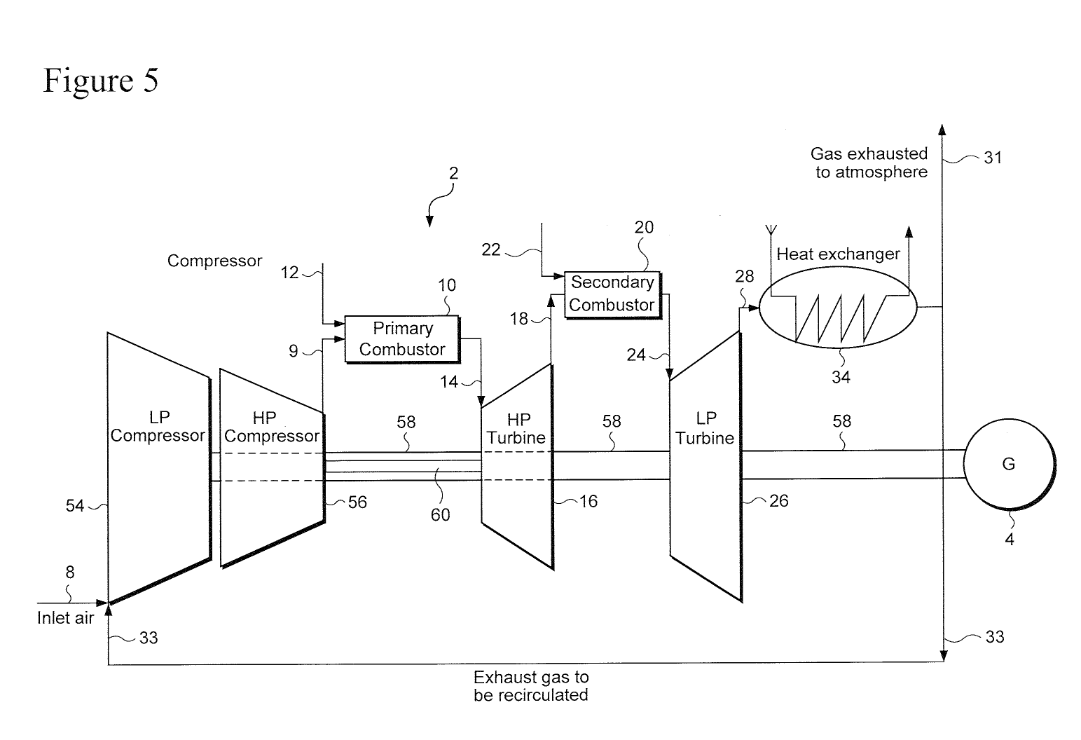

Referring to FIG. 5, the heat exchanger 34 is provided to receive the low pressure turbine exhaust gas 28 directly. After passing through the heat exchanger 34, the low pressure turbine exhaust gas 28 is divided into cooled atmosphere exhaust gas 31, which is exhausted to the atmosphere, and the cooled, uncompressed recirculated exhaust gas 33 is combined with inlet air 8 which is introduced into a low pressure compressor 54. The low pressure compressor 54 is connected to a high pressure compressor 56 which feeds the compressed air and gases to the primary combustor 10 for mixing with fuel 12.

The low pressure compressor 54, the low pressure turbine 26 and the generator 4 are supported by a common shaft 58. A second shaft 60 connects the high pressure compressor 56 and the high pressure turbine 16 to ensure that the high pressure compressor 56 and the high pressure turbine 16 rotate at the same speed.

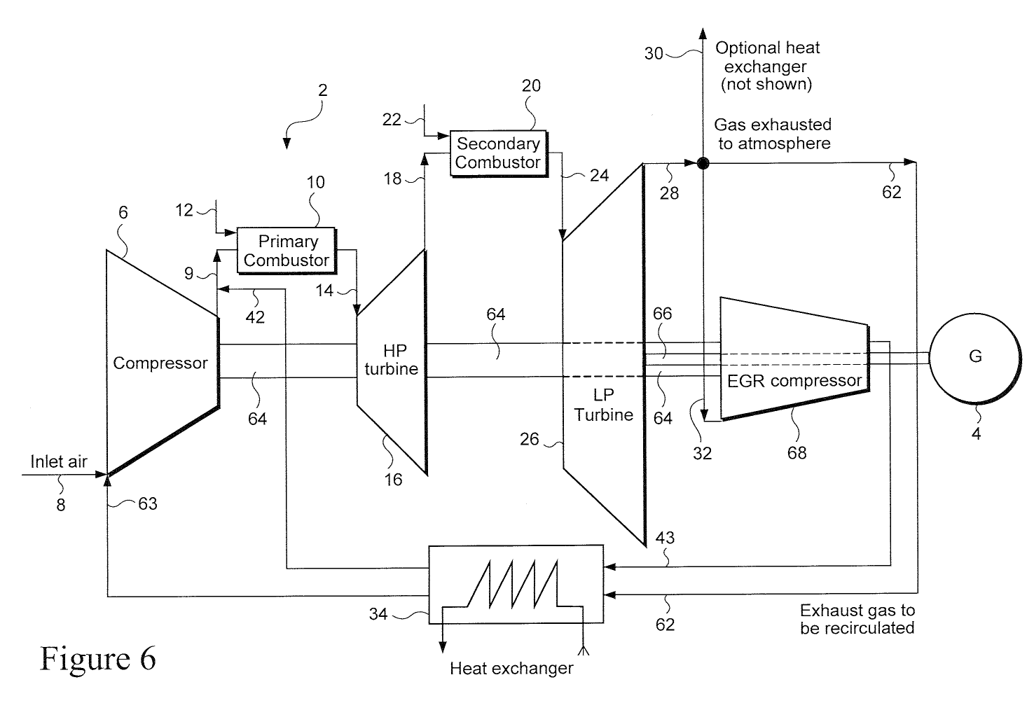

As shown in FIG. 6, according to another sample embodiment of the turbine system 2, the low pressure turbine exhaust gas 28 is divided into atmosphere exhaust gas 30 which is exhausted to the atmosphere, for example through an optional heat exchanger (not shown), and a first portion comprising an uncompressed, uncooled recirculated exhaust gas 62 which is passed through the heat exchanger 34. The low pressure turbine exhaust gas 28 is also further divided into the recirculated exhaust gas 32 which is compressed by a recirculated exhaust gas compressor 68. The compressed, uncooled recirculated exhaust gas 43 is also passed through the heat exchanger 34 and the compressed, cooled recirculated exhaust gas 42 is fed to the line from the compressor 6 to the primary combustor 10 to be added to the compressed inlet air 9. The cooled, uncompressed recirculated exhaust gas 63 which exits the heat exchanger 34 is combined with the inlet air 8 and the combined air and gases are subsequently fed to the compressor 6.

The compressor 6, the high pressure turbine 16, and the recirculated exhaust gas compressor 68 are connected by a first shaft 64. The low pressure turbine 26 and the generator 4 are connected by a second shaft 66 that ensures that the low pressure turbine 26 and the generator 4 rotate at the same speed.

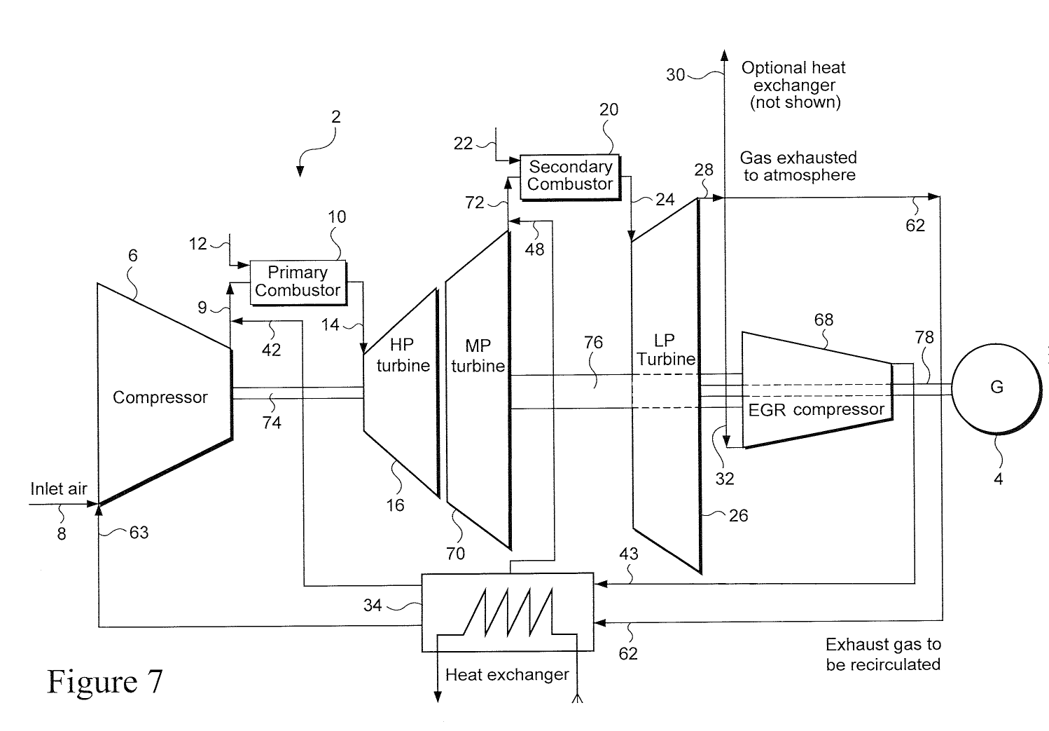

Referring to FIG. 7, a mid-pressure turbine 70 is provided between the high pressure turbine 16 and the low pressure turbine 26. The compressed, cooled recirculated exhaust gas 42 is fed to the line from the compressor 6 to the primary combustor 10 to be added to the compressed inlet air 9. The second portion of the uncompressed, uncooled recirculated exhaust gas 62 is passed through the heat exchanger 34 and the second portion of the cooled, uncompressed recirculated exhaust gas 63 is added to the inlet air 8 introduced to the compressor 6. The compressed, partially cooled recirculated exhaust gas 48 is fed from the heat exchanger 34 to the line between the mid-pressure turbine 70 and the secondary combustor 20 to be added to the mid-pressure turbine exhaust gas 72.

The compressor 6 and the high pressure turbine 16 are connected by a first shaft 74 to ensure that primary compression is powered by the high pressure turbine 16. The mid-pressure turbine 70 and the recirculated exhaust gas compressor 68 are supported by a second shaft 76. The low pressure turbine 26 and the generator 4 are connected by a third shaft 78 that ensures that the two components rotate at the same speed.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A turbine system, comprising:
a first compressor configured to compress gases;
a first combustor configured to mix the compressed gases with fuel and burn the mixture;
a first turbine configured to be driven by combustion gases of the first combustor;
a second combustor configured to mix exhaust gases from the first turbine with fuel and burn the mixture;
a second turbine configured to be driven by combustion gases from the second combustor; and
a generator configured to be driven by the turbine system,
wherein a first portion of the exhaust gases from the second turbine is recirculated for mixing in the first combustor.

2. A turbine system according to claim 1, wherein the first portion of the exhaust gases from the second turbine is recirculated for introduction into the first compressor.

3. A turbine system according to claim 1, further comprising:
a second compressor configured to compress the first portion of the exhaust gases from the second turbine, wherein the compressed first portion of the exhaust gases from the second turbine is mixed with compressed air from the first compressor prior to the first combustor.

4. A turbine system according to claim 3, wherein the second compressor is configured to compress the first portion of the exhaust gases from the second turbine before or after the first portion of the exhaust gases from the second turbine is cooled by a heat exchanger.

5. A turbine system according to claim 3, further comprising:
a third compressor configured to compress a second portion of the exhaust gases from the second turbine that has been partially cooled by a heat exchanger, wherein the compressed second portion of the exhaust gases from the second turbine is mixed with the exhaust gases from the first turbine prior to the second combustor.

6. A turbine system according to claim 1, further comprising:
a steam generator configured to generate steam; and
a steam turbine configured to be driven by the steam generated by the steam generator, wherein a second portion of the exhaust gases from the second turbine is routed to the steam generator to generate the steam.

7. A turbine system according to claim 1,wherein the first compressor comprises a low pressure compressor and a high pressure compressor.

8. A turbine system according to claim 1, wherein the first turbine comprises a high pressure turbine and the second turbine comprises a low pressure turbine.

9. A turbine system according to claim 1, wherein the first turbine comprises a high pressure turbine and a mid-pressure turbine and the second turbine comprises a low pressure turbine.

10. A turbine system according to claim 1, further comprising:
a shaft configured to rotatably connect the generator, the first compressor, the first turbine and the second turbine.

11. A turbine system according to claim 1, further comprising:
a first shaft configured to rotatably connect the first compressor and the first turbine; and
a second shaft configured to rotatably connect the second turbine and the generator.

12. A turbine system according to claim 7, further comprising:
a first shaft configured to rotatably connect the low pressure compressor, the second turbine and the generator; and
a second shaft configured to rotatably connect the high pressure compressor and the first turbine.

13. A turbine system according to claim 3, further comprising:
a first shaft configured to rotatably connect the first compressor, the first turbine, and the second compressor; and
a second shaft configured to rotatably connect the second turbine and the generator.

14. A turbine system according to claim 9, further comprising:
a first shaft configured to rotatably connect the first compressor and the high pressure turbine;
a second shaft configured to rotatably connect the mid-pressure turbine and a second compressor configured to compress the exhaust gases from the low pressure turbine; and
a third shaft configured to rotatably connect the low pressure turbine and the generator.

15. A method of operating a turbine system, comprising:
compressing gases with a first compressor;
mixing the compressed gases with fuel to form a first mixture and burning the first mixture;
driving a first turbine with combustion gases from burning the first mixture;
mixing exhaust gases from the first turbine with fuel to form a second mixture and burning the second mixture;
driving a second turbine with combustion gases from burning the second mixture; and
recirculating a first portion of the exhaust gases from the second turbine into the first mixture.

16. A method according to claim 15, further comprising:
cooling the first portion of the exhaust gases from the second turbine;
introducing the cooled first portion of the exhaust gases to the first compressor; and
combining the cooled first portion of the exhaust gases with inlet air.

17. A method according to claim 16, further comprising:
compressing the first portion of the exhaust gases from the second turbine prior to or after cooling the first portion of the exhaust gases from the second turbine.

18. A method according to claim 15, further comprising:
routing a second portion of the exhaust gases from the second turbine to a steam generator to generate steam; and
operating a steam turbine with the steam from the steam generator.

19. A method according to claim 15, further comprising recirculating a second portion of the exhaust gases from the second turbine into the second mixture.

20. A turbine system, comprising:
a plurality of compressors, each compressor configured to compress gases;
a plurality of combustors, each combustor configured to mix compressed gases with fuel and burn the mixture;
a plurality of turbines, each turbine configured to be driven by combustion gases of at least one of the plurality of combustors; and
a generator configured to be driven by the turbine system, wherein portions of the exhaust gases from at least some of the turbines are recirculated and introduced into at least some of the compressors.
